(19) United States
(12) Patent Application Publication
(10) Pub. No.: US 2026/0326436 A1
(43) Pub. Date: Oct. 22, 2026

(54) DRIVE DEVICE AND LIQUID EJECTION HEAD

(71) Applicant: RISO Technologies Corporation, Tokyo (JP)

(72) Inventor: Ryutaro KUSUNOKI, Mishima Shizuoka (JP)

(21) Appl. No.: 19/531,596

(22) Filed: Feb. 5, 2026

(30) Foreign Application Priority Data
Apr. 22, 2025 (JP) 2025-070406

(51) Int. Cl. B41J 2/045; B41J 2/14

(52) U.S. Cl. CPC B41J 2/04588; B41J 2/04541; B41J 2/04548; B41J 2/0455; B41J 2/04581; B41J 2/04596; B41J 2/14233

(57) ABSTRACT

A drive device for driving a liquid ejection head that includes a pressure chamber for storing liquid, a nozzle plate having a nozzle for ejecting the liquid, a vibration plate for pressurizing the liquid in the pressure chamber, and an actuator configured to drive the vibration plate, the drive device includes: one or more circuits configured to input a drive waveform to the actuator of the liquid ejection head. The drive waveform includes: an ejection pulse that causes the liquid to be ejected from the nozzle, a first cancel pulse that cancels a residual vibration generated in the liquid in the pressure chamber by the ejection pulse, and a second cancel pulse that cancels a residual vibration remaining in the actuator after an input of the first cancel pulse.

### CROSS-REFERENCE TO RELATED APPLICATION

This application is based upon and claims the benefit of priority from Japanese Patent Application No. 2025-070406, filed on Apr. 22, 2025, the entire contents of which are incorporated herein by reference.

### FIELD

Embodiments described herein relate generally to a drive device and a liquid ejection head.

### BACKGROUND

In the related art, a piezoelectric liquid ejection head that ejects a liquid such as ink is known. For example, as such a push-type liquid ejection head, a configuration including a pressure chamber that accommodates ink, a nozzle that is connected to one end of the pressure chamber and ejects the ink, a supply flow path that is connected to the other end of the pressure chamber, a vibration plate that seals the supply flow path side of the pressure chamber, and an actuator that pressurizes the ink in the pressure chamber via the vibration plate is known. The liquid ejection head ejects droplets when a drive waveform generated by a drive device provided in the liquid ejection head or in a liquid ejection apparatus on which the liquid ejection head is mounted is input to an actuator corresponding to a pressure chamber that ejects a liquid.

For example, the liquid ejection head applies a drive waveform to the actuator, increases the voltage from a standby voltage to increase the volume of the pressure chamber, returns the voltage to the standby voltage to decrease the volume, pressurizes the ink in the pressure chamber, and ejects the ink from the nozzle.

With the drive waveform described above, a residual vibration remains in the pressure chamber after the ink is ejected, air bubbles are entrained from the meniscus in the nozzle after the ink is ejected, or an ejection speed or a volume of the ink in the subsequent ink ejection varies due to an influence of a previous ejection operation, so that the drive frequency cannot be increased.

### BRIEF DESCRIPTION OF THE DRAWINGS

FIG. 1 is a cross-sectional view illustrating a configuration of a liquid ejection head according to an embodiment.

FIG. 2 is a diagram illustrating an example of a configuration of a drive device for the liquid ejection head.

FIG. 3 is a diagram illustrating another example of the configuration of the drive device.

FIGS. 4A and 4B are diagrams illustrating an example of a drive waveform and a flow velocity vibration.

FIGS. 5A and 5B are diagrams illustrating an example of a drive waveform and a flow velocity vibration according to a comparative example.

### DETAILED DESCRIPTION

According to the present disclosure, it is possible to provide a drive device and a liquid ejection head capable of improving a drive frequency.

In general, according to one embodiment, a drive device for driving a liquid ejection head that includes a pressure chamber for storing liquid, a nozzle plate having a nozzle for ejecting the liquid, a vibration plate for pressurizing the liquid in the pressure chamber, and an actuator configured to drive the vibration plate, the drive device comprises one or more circuits configured to input a drive waveform to the actuator of the liquid ejection head. The drive waveform includes: an ejection pulse that causes the liquid to be ejected from the nozzle, a first cancel pulse that cancels a residual vibration generated in the liquid in the pressure chamber by the ejection pulse, and a second cancel pulse that cancels a residual vibration remaining in the actuator after an input of the first cancel pulse.

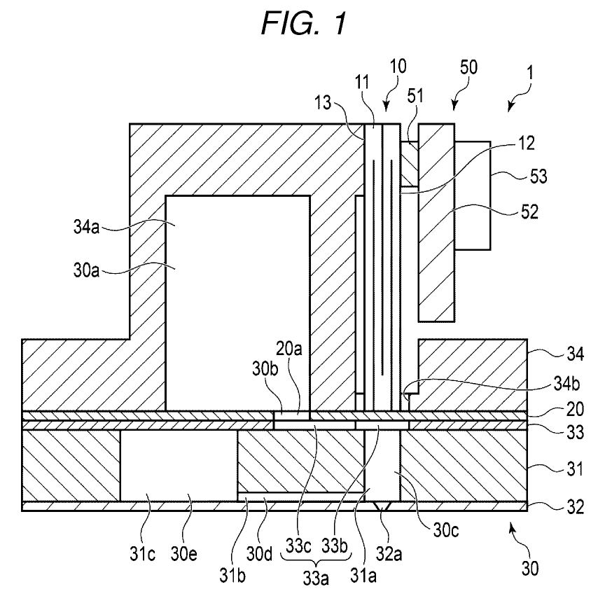

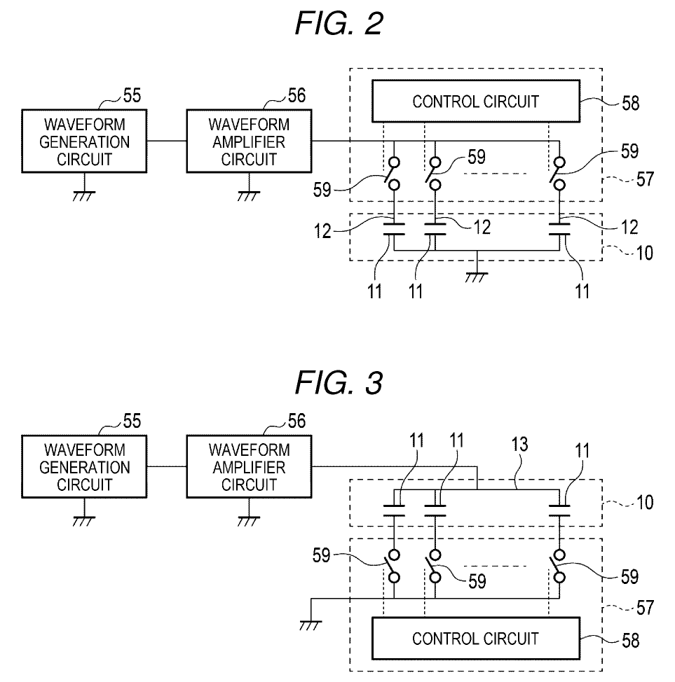

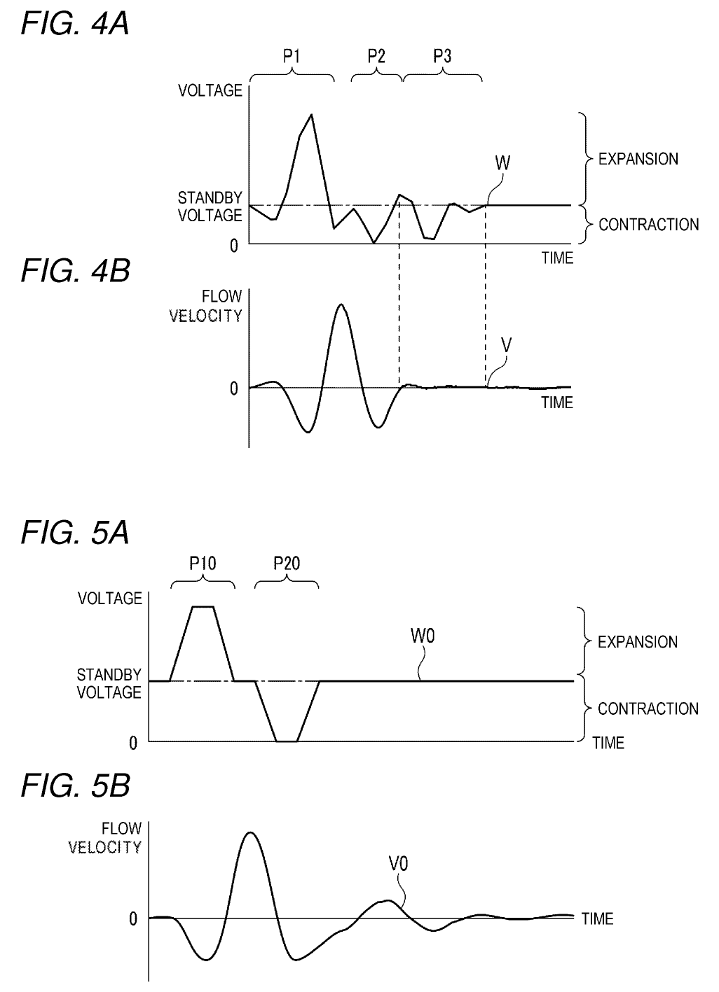

Hereinafter, a liquid ejection head 1 and a drive device 50 according to an embodiment will be described with reference to FIGS. 1-5. FIG. 1 is a cross-sectional view schematically illustrating a configuration of the liquid ejection head 1, and FIG. 2 is a diagram illustrating an example of a configuration of the drive device 50 of the liquid ejection head 1. FIG. 3 is a diagram illustrating another example of the configuration of the drive device 50. FIGS. 4A and 4B are diagrams illustrating an example of a drive waveform and a flow velocity vibration of the liquid ejection head 1, and FIGS. 5A and 5B are diagrams illustrating an example of a drive waveform and a flow velocity vibration of a liquid ejection head according to a comparative example. In the present embodiment, an upper-lower direction is defined with a nozzle plate 32 side of the liquid ejection head 1 as a lower side and an upper body 34 side as an upper side, and is described below.

The liquid ejection head 1 is, for example, a push-type inkjet head that ejects ink as a liquid onto a recording medium such as a paper sheet. The liquid ejection head 1 is provided in a liquid ejection apparatus such as an inkjet recording apparatus.

Ink stored in a supply tank provided in the liquid ejection apparatus is supplied to the liquid ejection head 1. The liquid ejection head 1 may be a circulation type head that circulates ink, or may be a non-circulation type head that does not circulate ink.

As illustrated in FIG. 1, the liquid ejection head 1 includes, for example, an actuator 10, a vibration plate 20, a flow path member 30, and a drive device 50. The liquid ejection head 1 causes the actuator 10, driven by an input of a drive waveform W generated by the drive device 50, to vibrate the vibration plate 20 so as to change a volume of a pressure chamber 30c, and ejects the ink accommodated or stored in the pressure chamber 30c from a nozzle 32a.

The actuator 10 includes, for example, a plurality of piezoelectric elements 11 formed by stacking or laminating piezoelectric members such as PZT, a plurality of individual electrodes 12 provided on the respective piezoelectric elements 11, and one or a plurality of common electrodes 13 provided on the plurality of piezoelectric elements 11.

For example, the plurality of piezoelectric elements 11 are arranged in one direction and fixed to the vibration plate 20 and the flow path member 30. For example, the plurality of piezoelectric elements 11 are disposed to face the plurality of pressure chambers 30c formed in the flow path member 30 via the vibration plate 20, respectively.

The piezoelectric element 11 deforms when a voltage is applied to the individual electrode 12 or the common electrode 13 by the drive device 50. For example, the plurality of piezoelectric members of the piezoelectric element 11 are stacked in a lateral direction, and when an electric field is applied, the piezoelectric element 11 is deformed in a direction orthogonal to a stacking direction of the plurality of piezoelectric members, thereby deforming the vibration plate 20. That is, the piezoelectric element 11 is deformed in a d31 mode. The electrodes 12, 13 formed on each piezoelectric element 11 are connected to a control unit of the liquid ejection apparatus via the drive device 50 (drive circuit), and are driven and controlled by the control unit. When a predetermined voltage is input, the piezoelectric element 11 expands and contracts according to a voltage value. For example, the piezoelectric element 11 enters a standby state in which the piezoelectric element 11 is not deformed when a reference voltage is input, and when a voltage lower than the reference voltage is applied, the piezoelectric element 11 extends in one direction orthogonal to the stacking direction of the piezoelectric members, and when a voltage higher than the reference voltage is applied, the piezoelectric element 11 contracts in one direction orthogonal to the stacking direction of the piezoelectric members.

The actuator 10 can deform the piezoelectric element 11 in a d33 mode. In a case of the d33 mode, the piezoelectric members are stacked in a vertical direction, and when an electric field is applied, the piezoelectric element 11 is deformed in the stacking direction to deform the vibration plate 20. In the case of the d33 mode, when a voltage higher than the reference voltage is applied, the piezoelectric element 11 expands in the laminating direction of the piezoelectric members, and when a voltage lower than the reference voltage is applied, the piezoelectric element 11 contracts in the stacking direction of the piezoelectric members.

In the example according to the present embodiment, the d31 mode, that is, an example in which the piezoelectric element 11 expands when a voltage lower than the reference voltage is applied and contracts when a voltage higher than the reference voltage is applied will be described.

The plurality of individual electrodes 12 are formed on the plurality of piezoelectric elements 11, respectively. Each of the plurality of individual electrodes 12 is electrically connected to each of the plurality of piezoelectric elements 11.

The common electrode 13 is electrically connected in common to the plurality of piezoelectric elements 11. For example, one common electrode 13 is provided and electrically connected to all of the plurality of piezoelectric elements 11. The plurality of common electrodes 13 may be provided, and each common electrode 13 may electrically connect to some piezoelectric elements 11 of the plurality of piezoelectric elements 11.

The plurality of piezoelectric elements 11 are fixed to the vibration plate 20. The vibration plate 20 deforms as the actuator 10 expands and contracts. The vibration plate 20 is, for example, a metal plate. The vibration plate 20 extends along a plane orthogonal to a vibration direction, that is, an expansion and contraction direction of the actuator 10 fixed to the vibration plate 20. The vibration plate 20 is bonded to the plurality of piezoelectric elements 11 and supported by the flow path member 30. For example, the vibration plate 20 is deformed by displacement of a vibration portion to which the piezoelectric element 11 is bonded due to the expansion and contraction of the piezoelectric element 11. For example, the vibration plate 20 is fixed between a flow path plate 33 and an upper body 34, which will be described later, of the flow path member 30, and a region to which the actuator 10 is fixed is exposed from a part of the upper body 34. For example, the vibration plate 20 is provided with a plurality of openings 20a that are disposed to face an upper common flow path 30a, which will be described later, of the flow path member 30 and that face a plurality of upper individual flow paths 30b, respectively. For example, the vibration plate 20 is formed in a rectangular plate shape elongated in one direction, and the plurality of piezoelectric elements 11 and the plurality of openings 20a are disposed at predetermined intervals along a longitudinal direction.

The flow path member 30 includes a lower body 31, a nozzle plate 32, the flow path plate 33, and the upper body 34. The flow path member 30 holds the actuator 10 and the vibration plate 20. In the flow path member 30, the upper common flow path 30a, the plurality of upper individual flow paths 30b connected to the upper common flow path 30a, the plurality of pressure chambers 30c connected to the plurality of upper individual flow paths 30b, a plurality of lower individual flow paths 30d connected to the plurality of pressure chambers 30c, and a lower common flow path 30e connected to the plurality of lower individual flow paths 30d are formed by the lower body 31, the nozzle plate 32, the flow path plate 33, and the upper body 34.

The lower body 31 is formed in, for example, a rectangular plate shape elongated in one direction. For example, the nozzle plate 32 is fixed to a lower main surface of two main surfaces of the lower body 31 in the upper-lower direction, and the flow path plate 33 is fixed to an upper main surface. The lower body 31 includes a plurality of first through holes 31a forming the plurality of pressure chambers 30c, a plurality of grooves 31b formed in the lower main surface and forming the plurality of lower individual flow paths 30d, and one second through hole 31c forming the lower common flow path 30e. An ink port for supplying or discharging ink to or from the lower common flow path 30e is formed in the lower body 31.

The plurality of first through holes 31a are formed side by side at predetermined intervals along a longitudinal direction of the lower body 31. An arrangement direction of the plurality of first through holes 31a (the plurality of pressure chambers 30c) is the same as an arrangement direction of the plurality of piezoelectric elements 11. The plurality of grooves 31b are provided in the same number as the plurality of first through holes 31a (the plurality of pressure chambers 30c). For example, the plurality of grooves 31b extend along a lateral direction of the lower body 31 and are formed side by side at predetermined intervals along the longitudinal direction of the lower body 31. One end of each groove 31b is continuous with each first through hole 31a, and the other end is continuous with the second through hole 31c.

The nozzle plate 32 is fixed to the lower main surface of the lower body 31 and covers at least the plurality of first through holes 31a, the plurality of grooves 31b, and the second through hole 31c of the lower body 31. The nozzle plate 32 is formed in, for example, a rectangular plate shape elongated in one direction and having the same shape as the lower main surface of the lower body 31. A plurality of nozzles 32a are formed in the nozzle plate 32 at positions facing the plurality of first through holes 31a. As an example, the plurality of nozzles 32a are formed side by side along a longitudinal direction of the nozzle plate 32. In other words, an arrangement direction of the plurality of nozzles 32a is, for example, the same direction as the arrangement direction of the plurality of first through holes 31a (the plurality of pressure chambers 30c) and the plurality of piezoelectric elements 11.

The flow path plate 33 is fixed to the upper main surface of the lower body 31 and covers at least the plurality of first through holes 31a and the second through hole 31c of the lower body 31. The flow path plate 33 is formed in, for example, a rectangular plate shape elongated in one direction and having the same shape as the upper main surface of the lower body 31. For example, the lower body 31 is fixed to a lower main surface of the flow path plate 33, and the vibration plate 20 is fixed to an upper main surface of the flow path plate 33. In the flow path plate 33, for example, a plurality of third through holes 33a forming the plurality of upper individual flow paths 30b are formed.

For example, the plurality of third through holes 33a are formed side by side at predetermined intervals along the longitudinal direction of the flow path plate 33. For example, the third through hole 33a includes a pressure chamber end hole 33b forming an upper end of the pressure chamber 30c, and a flow path hole 33c having one end disposed at a position facing a part of the upper common flow path 30a and the other end continuous with the pressure chamber 30c (pressure chamber end hole 33b). The pressure chamber end hole 33b is continuous with an upper end of the first through hole 31a. For example, an opening area of the pressure chamber end hole 33b is larger than an opening area of the first through hole 31a of the lower body 31.

One end of each flow path hole 33c is disposed to face each opening 20a of the vibration plate 20. The flow path hole 33c forms the upper individual flow path 30b together with the opening 20a of the vibration plate 20.

The upper body 34 is fixed to an upper main surface of the vibration plate 20. In the upper body 34, a groove 34a forming the upper common flow path 30a and a plurality of openings 34b formed in a region where the actuator 10 is disposed on the vibration plate 20 are formed. The groove 34a opens in a lower main surface of the upper body 34. The opening 34b is, for example, a through hole. The plurality of openings 34b are disposed at positions facing the plurality of pressure chambers 30c via the vibration plate 20. An opening shape of the opening 34b is, for example, the same shape as an opening shape of the upper end (pressure chamber end hole 33b) of the pressure chamber 30c. The actuator 10 is bonded to the upper body 34 at a position corresponding to the pressure chamber 30c via the vibration plate 20. For example, an interconnect substrate 52, which will be described later, of the drive device 50 is fixed to the upper body 34. An ink port for supplying or discharging ink to or from the upper common flow path 30a is formed in the upper body 34.

The lower body 31, the nozzle plate 32, the flow path plate 33, and the upper body 34 of the flow path member 30 as described above are integrally bonded with the vibration plate 20 interposed between the flow path plate 33 and the upper body 34, so that the upper common flow path 30a, the plurality of upper individual flow paths 30b, the plurality of pressure chambers 30c, the plurality of lower individual flow paths 30d, and the lower common flow path 30e that are fluidly continuous are formed.

As a specific example, the vibration plate 20 is bonded to the lower main surface of the upper body 34, and a lower end of the groove 34a of the upper body 34 is covered by the vibration plate 20, thereby forming the upper common flow path 30a opened at the plurality of openings 20a of the vibration plate 20. For example, the upper common flow path 30a constitutes a common supply flow path, but may be a common discharge flow path.

As a specific example, the vibration plate 20 and the lower body 31 are bonded to the upper and lower main surfaces of the flow path plate 33, so that the plurality of upper individual flow paths 30b are formed by the plurality of openings 20a of the vibration plate 20 and the plurality of flow path holes 33c of the flow path plate 33. Specifically, the plurality of flow path holes 33c of the flow path plate 33 are covered by the vibration plate 20 and the lower body 31 in the upper-lower direction, and end portions of the plurality of flow path holes 33c are disposed to face the plurality of openings 20a of the vibration plate 20, so that the plurality of upper individual flow paths 30b continuous with the upper common flow path 30a and the plurality of pressure chambers 30c are formed.

As a specific example, the nozzle plate 32 and the flow path plate 33 are bonded to the upper and lower main surfaces of the lower body 31, and the vibration plate 20 is bonded to the upper main surface of the flow path plate 33, thereby forming the plurality of pressure chambers 30c. Specifically, lower ends of the plurality of first through holes 31a of the lower body 31 are covered by the nozzle plate 32. The upper ends of the plurality of first through holes 31a are continuous with lower ends of the plurality of pressure chamber end holes 33b of the flow path plate 33, and upper ends of the plurality of pressure chamber end holes 33b are covered by the vibration plate 20. As a result, the plurality of nozzles 32a of the nozzle plate 32 are respectively disposed, and the plurality of pressure chambers 30c that contain ink are formed.

As a specific example, the nozzle plate 32 is bonded to the lower main surface of the lower body 31, and the plurality of grooves 31b formed in the lower main surface of the lower body 31 are covered by the nozzle plate 32, thereby forming the plurality of lower individual flow paths 30d.

As a specific example, the nozzle plate 32 and the flow path plate 33 are bonded to the upper and lower main surfaces of the lower body 31, and upper and lower ends of the second through hole 31c are covered by the nozzle plate 32 and the flow path plate 33, thereby forming the lower common flow path 30e continuous with the plurality of lower individual flow paths 30d. The lower common flow path 30e constitutes a common discharge flow path, but may be a common supply flow path.

In the flow path member 30 described above, when ink is injected from the ink port serving as an ink supply port of the upper body 34, the plurality of pressure chambers 30c are filled with the ink from the upper common flow path 30a via each of the plurality of upper individual flow paths 30b, and the ink is discharged from the ink port serving as an ink discharge port of the lower body 31 via the plurality of lower individual flow paths 30d and the lower common flow path 30e.

The drive device 50 includes, for example, an anisotropic conductive member 51, the interconnect substrate 52, and a connector 53. The drive device 50 is a drive circuit that drives the actuator 10. The anisotropic conductive member 51, for example, electrically connects the plurality of individual electrodes 12 and the common electrode 13 of the actuator 10 to the interconnect substrate 52. Alternatively, the common electrode 13 may be electrically connected to the interconnect substrate 52 not via the anisotropic conductive member 51 but via another conductive member.

The interconnect substrate 52 includes, for example, a drive IC and includes various circuits required to drive the actuator 10. For example, the interconnect substrate 52 drives the piezoelectric element 11 by inputting a drive voltage (drive waveform) to each of the electrodes 12, 13 of the piezoelectric element 11, increases or decreases the volume of the pressure chamber 30c, and ejects a droplet from the nozzle 32a. The interconnect substrate 52 generates a control signal and a drive signal for controlling each piezoelectric element 11 such as a signal for selecting a timing for ejecting the liquid and selecting the piezoelectric element 11 for ejecting the liquid according to an image signal received from the control unit of the liquid ejection apparatus. For example, the drive IC includes a data buffer, a decoder, and a driver, and is connected to the control unit of the liquid ejection apparatus via the connector 53.

Alternatively, the interconnect substrate 52 may not include the drive IC, and the individual electrode 12 and the common electrode 13 of the actuator 10 may be directly electrically connected to the connector 53. The connector 53 includes, for example, a plurality of terminals electrically and independently connected to each of the plurality of individual electrodes 12 and the common electrode 13 via the anisotropic conductive member 51 and the interconnect substrate 52. For example, the connector 53 is formed to be connectable to an electric cable, and is electrically connected to the drive device 50 of the liquid ejection apparatus provided separately from the liquid ejection head 1.

The drive device 50 described above selectively drives the actuator 10 corresponding to the pressure chamber 30c that ejects the ink based on the image signal. As a specific example, as illustrated in FIG. 2, the drive device 50 includes a waveform generation circuit 55, a waveform amplifier circuit 56, and a waveform selection circuit 57.

The waveform generation circuit 55 generates the drive waveform W having a preset shape and inputs the drive waveform to the waveform amplifier circuit 56. The waveform amplifier circuit 56 amplifies the drive waveform W and inputs the amplified drive waveform W to the waveform selection circuit 57.

The waveform selection circuit 57 includes, for example, a control circuit 58 and a plurality of analog switches 59. The control circuit 58 controls ON and OFF switching of the analog switches 59 based on the image signal. An ON channel inputs the drive waveform W to the actuator 10. An OFF channel has high impedance, and the actuator 10 is not driven. That is, the control circuit 58 turns on the analog switch 59 corresponding to the actuator 10 that is selectively driven based on the image signal. In the example in FIG. 2, the analog switches 59 of the waveform selection circuit 57 are provided on a side of the plurality of individual electrodes 12, and the drive waveform W is applied to the individual electrode 12 of the selected actuator 10. FIG. 3 illustrates another example of the drive device 50 (drive circuit). In the example in FIG. 3, the drive waveform W is applied to the common electrode 13 side, and by turning on the analog switch 59 corresponding to the actuator 10 to be driven among the individual electrodes 12, the individual electrode 12 is grounded, and the selected actuator 10 is driven. Further, by turning off the analog switch 59 not corresponding to the actuator 10 to be driven, the individual electrode 12 of the actuator 10 not to be driven becomes high impedance, a potential of the individual electrode 12 becomes the same as that of the common electrode 13, and the actuator 10 is not driven.

The liquid ejection head 1 having the configuration as described above is in a standby state in a state in which the flow path member 30 is filled with ink and pressures of the ink supply port and the ink discharge port are controlled to appropriate values such that a pressure at the nozzle 32a becomes a weak negative pressure with respect to atmospheric pressure. In the liquid ejection head 1, when the drive waveform W is applied from the drive device 50 to the actuator 10, the actuator 10 expands and contracts, and the vibration plate 20 vibrates. When the vibration plate 20 vibrates, the pressure of the pressure chamber 30c fluctuates, and the ink is ejected from the nozzle 32a.

In the push-type liquid ejection head 1 having the configuration as described above, a movable portion of the actuator 10 is long, and a structural natural vibration frequency of the actuator 10 is close to a fluid natural vibration frequency of the ink in the pressure chamber 30c. Therefore, a residual vibration of the ink in the pressure chamber 30c is affected by both a fluid residual vibration of the ink itself and a structural residual vibration of the actuator 10.

Next, a configuration of the drive waveform W received from the drive device 50 (drive circuit) will be described with reference to FIGS. 4A and 4B. As a comparative example to be compared with the drive waveform W according to the present embodiment, a configuration of a drive waveform W0 according to the comparative example will be described with reference to FIGS. 5A and 5B.

FIGS. 4A and 5A illustrate the drive waveforms W and W0, respectively, in which a vertical axis represents a voltage and a horizontal axis represents time. In FIGS. 4A and 5A, a standby voltage is indicated by a one-dot chain line, and the drive waveforms W and W0 are indicated by solid lines. In the example of the drive waveform W according to the present embodiment and the example of the drive waveform W0 according to the comparative example, when a voltage higher than the standby voltage is applied, the actuator 10 contracts and the volume of the pressure chamber 30c expands, and when a voltage lower than the standby voltage is applied, the actuator 10 expands and the volume of the pressure chamber 30c contracts.

In a case where the actuator 10 is implemented in the d33 mode or the like, when a voltage higher than the standby voltage is applied, the actuator 10 may expand and the volume of the pressure chamber 30c may contract, and when a voltage lower than the standby voltage is applied, the actuator 10 may contract and the volume of the pressure chamber 30c may expand. In this case, the drive waveform W in FIG. 4A has a vertically inverted shape with the standby voltage as a symmetric axis.

FIGS. 4B and 5B illustrate flow velocity vibrations V and V0, respectively, generated in an ink meniscus of the nozzle 32a when the drive waveforms W and W0 are applied, and a vertical axis indicates a flow velocity and a horizontal axis indicates time. The flow velocity vibration of the ink meniscus of the nozzle 32a reflects the fluid vibration of the ink in the pressure chamber 30c. Therefore, a state in which there is no flow velocity vibration of the ink meniscus of the nozzle 32a can be regarded as a state in which there is no residual vibration of the ink in the pressure chamber 30c.

The flow velocity vibration described above can be measured by irradiating the ink meniscus in the nozzle 32a with laser light of a laser Doppler vibrometer in a state in which a voltage amplitude of the drive waveform W is sufficiently reduced to an extent that the ink is not ejected from the nozzle 32a and is applied to the actuator 10.

As illustrated in FIG. 4A, the drive waveform W includes an ejection pulse P1 for ejecting ink, a first cancel pulse P2 for canceling a residual vibration of the ink generated in the pressure chamber 30c by an ejection operation by the ejection pulse P1, and a second cancel pulse P3 for canceling a residual vibration remaining in the actuator 10 after the first cancel pulse P2 is input.

A voltage change of the ejection pulse P1 starts from the standby voltage, changes to a voltage that expands the volume of the pressure chamber 30c (hereinafter, simply referred to as a volume) relative to the standby voltage, and then ends at a voltage that causes the volume to contract relative to the standby voltage. Accordingly, the volume expands and then contracts, the ink in the pressure chamber 30c is pressurized, and the ink is ejected from the nozzle 32a.

A voltage change of the first cancel pulse P2 starts from a voltage that expands the volume relative to an end voltage of the ejection pulse P1, changes to a voltage that causes the volume to contract relative to the standby voltage, and then ends at the voltage that expands the volume relative to the standby voltage. In other words, the voltage change of the first cancel pulse P2 starts from a voltage that is closer to the standby voltage than the end voltage of the ejection pulse P1 and causes the volume to contract, changes to the voltage that causes the volume to contract more than at the start of the first cancel pulse P2, for example, a voltage lower than the end voltage of the ejection pulse P1, and ends at the voltage that expands the volume relative to the standby voltage. The residual vibration of the ink in the pressure chamber 30c is canceled by the first cancel pulse P2 as indicated by the flow velocity vibration V in FIG. 4B. Since the volume corresponding to the voltage at the end of the ejection pulse P1 is smaller than the volume at the standby voltage and the volume corresponding to the voltage at the start of the first cancel pulse P2 is larger than the volume corresponding to the voltage at the end of the ejection pulse P1, the voltage applied to the actuator 10 after the end of the ejection pulse P1 and before the start of the first cancel pulse P2 changes in a direction in which the volume increases.

A voltage change of the second cancel pulse P3 starts from the end voltage of the first cancel pulse P2, changes to a voltage that causes the volume to contract relative to the standby voltage, and then ends at the standby voltage. For example, the second cancel pulse P3 is input following the first cancel pulse P2. The voltage change of the second cancel pulse P3 that causes the volume to contract is performed a plurality of times as necessary.

As indicated by the flow velocity vibration V in FIG. 4B, a state in which the flow velocity vibration is canceled by the first cancel pulse P2 is maintained during the application of the second cancel pulse P3. That is, a driving force generated in the actuator 10 by the second cancel pulse P3 cancels out vibration energy remaining in the actuator 10 without changing the volume of the pressure chamber 30c.

According to the drive waveform W, the residual vibration of the ink in the pressure chamber 30c is canceled by the first cancel pulse P2, the residual vibration remaining in the actuator 10 is canceled by the second cancel pulse P3, and the residual vibrations of both the ink in the pressure chamber 30c and the actuator 10 are canceled. Therefore, the liquid ejection head 1 can implement a high drive frequency. Here, the drive frequency means the number of ink droplets ejected per unit time (the number of ink droplet ejections). The voltages and times of the ejection pulse P1, the first cancel pulse P2, and the second cancel pulse P3 can be appropriately set as long as the residual vibrations generated in the ink in the pressure chamber 30c and the actuator 10 can be reduced.

On the other hand, as illustrated in FIG. 5A, the drive waveform W0 according to the comparative example includes an ejection pulse P10 for ejecting ink and a cancel pulse P20 for canceling the residual vibration generated in the pressure chamber 30c by the ejection operation of the ejection pulse P10. A voltage change of the ejection pulse P10 starts from the standby voltage, changes to the voltage that expands the volume relative to the standby voltage, and then ends at the standby voltage. The cancel pulse P20 starts from the standby voltage, changes to the voltage that causes the volume to contract relative to the standby voltage, and then ends at the standby voltage. The cancel pulse P20 reduces the residual vibration generated by the ejection pulse P10, but cannot cancel the residual vibrations of both the ink in the pressure chamber 30c and the actuator 10, and as indicated by the flow velocity vibration V0 in FIG. 5B, the residual vibration remains even after the cancel pulse P20 is input, and the residual vibration is not sufficiently eliminated. Therefore, it can be seen that the high drive frequency cannot be achieved when the drive waveform W0 is applied to the liquid ejection head 1.

As described above, in the liquid ejection head 1, the drive waveform W input to the actuator 10 by the drive device 50 is input as the ejection pulse P1, and then the first cancel pulse P2 and the second cancel pulse P3 are input to cancel the residual vibrations, so that the drive frequency can be improved.

It should be noted that embodiments of the present disclosure are not limited to the above-described configurations. For example, the configuration in which the drive device 50 is provided in the liquid ejection head 1 has been described. However, the configuration and arrangement of the drive device 50 (drive circuit) are not limited as long as the drive waveform W can be generated and input to the actuator 10. For example, the drive device 50 may be provided separately from the liquid ejection head 1, or a part of the drive device 50 (a part of the drive circuit) may be provided in the liquid ejection head 1, and a remaining part of the drive device 50 (a remaining part of the drive circuit) may be provided in the liquid ejection apparatus on which the liquid ejection head 1 is mounted. When it is not necessary to selectively drive the actuators 10 and all the actuators 10 are simultaneously driven, the waveform selection circuit 57 may be omitted.

In the example described above, an example of the flow path member 30 has been described, but the configuration of the flow path member 30 can be appropriately set as long as a flow path capable of supplying ink to the pressure chamber 30c can be formed. For example, in the example described above, the plurality of upper individual flow paths 30b are formed by the plurality of openings 20a of the vibration plate 20 and the plurality of flow path holes 33c of the flow path plate 33. However, the opening 20a of the vibration plate 20 may be one hole that is continuous with the plurality of flow path holes 33c and is elongated in one direction. For example, the vibration plate 20 may be provided only in a region facing the actuator 10 and the pressure chamber 30c.

According to the liquid ejection head of at least one embodiment described above, it is possible to improve the drive frequency by including the ejection pulse, the first cancel pulse, and the second cancel pulse in the drive waveform.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying embodiments and their equivalents are intended to cover such forms or modifications as would fall within the scope and spirit of the disclosure.

What is claimed is:

1. A drive device for driving a liquid ejection head that includes a pressure chamber for storing liquid, a nozzle plate having a nozzle for ejecting the liquid, a vibration plate for pressurizing the liquid in the pressure chamber, and an actuator configured to drive the vibration plate, the drive device comprising:
one or more circuits configured to input a drive waveform to the actuator of the liquid ejection head, wherein
the drive waveform includes:
an ejection pulse that causes the liquid to be ejected from the nozzle,
a first cancel pulse that cancels a residual vibration generated in the liquid in the pressure chamber by the ejection pulse, and
a second cancel pulse that cancels a residual vibration remaining in the actuator after an input of the first cancel pulse.

2. The drive device according to claim 1, wherein
a flow velocity vibration of the liquid in the nozzle is canceled during application of the second cancel pulse.

3. The drive device according to claim 1, wherein
a voltage applied by the ejection pulse changes from a standby voltage to a voltage that expands a volume of the pressure chamber relative to the standby voltage, and then ends at an end voltage that causes the volume to contract relative to the standby voltage.

4. The drive device according to claim 3, wherein
a voltage applied by the first cancel pulse changes from a voltage that expands the volume relative to the end voltage applied by the ejection pulse to a voltage that causes the volume to contract relative to the standby voltage, and then ends at an end voltage that expands the volume relative to the standby voltage.

5. The drive device according to claim 4, wherein
a voltage applied by the second cancel pulse changes from the end voltage applied by the first cancel pulse to a voltage that causes the volume to contract relative to the standby voltage, and then ends at the standby voltage.

6. The drive device according to claim 1, wherein
the one or more circuits include:
a waveform generation circuit configured to generate the drive waveform,
a waveform amplification circuit configured to amplify the drive waveform, and
a waveform selection circuit configured to select the actuator to which the drive waveform is input.

7. The drive device according to claim 6, wherein
the waveform selection circuit includes a plurality of analog switches and a control circuit, and
the control circuit is configured to control ON and OFF switching of the plurality of switches based on an image signal.

8. The drive device according to claim 1, wherein
the second cancel pulse is input continuously following the first cancel pulse.

9. A liquid ejection head comprising:
a pressure chamber for storing liquid;
a nozzle plate having a nozzle for ejecting the liquid;
a vibration plate for pressurizing the liquid in the pressure chamber;
an actuator configured to drive the vibration plate; and
a drive device configured to input a drive waveform to the actuator, wherein
the drive waveform includes:
an ejection pulse that causes the liquid to be ejected from the nozzle,
a first cancel pulse that cancels a residual vibration generated in the liquid in the pressure chamber by the ejection pulse, and
a second cancel pulse that cancels a residual vibration remaining in the actuator after an input of the first cancel pulse.

10. The liquid ejection head according to claim 9, wherein
a flow velocity vibration of the liquid in the nozzle is canceled during application of the second cancel pulse.

11. The liquid ejection head according to claim 9, wherein
a voltage applied by the ejection pulse changes from a standby voltage to a voltage that expands a volume of the pressure chamber relative to the standby voltage, and then ends at an end voltage that causes the volume to contract relative to the standby voltage.

12. The liquid ejection head according to claim 11, wherein
a voltage applied by the first cancel pulse changes from a voltage that expands the volume relative to the end voltage applied by the ejection pulse to a voltage that causes the volume to contract relative to the standby voltage, and then ends at an end voltage that expands the volume relative to the standby voltage.

13. The liquid ejection head according to claim 12, wherein
a voltage applied by the second cancel pulse changes from the end voltage applied by the first cancel pulse to a voltage that causes the volume to contract relative to the standby voltage, and then ends at the standby voltage.

14. The liquid ejection head according to claim 9, wherein
the drive device includes:
a waveform generation circuit configured to generate the drive waveform,
a waveform amplification circuit configured to amplify the drive waveform, and
a waveform selection circuit configured to select the actuator to which the drive waveform is input.

15. The liquid ejection head according to claim 14, wherein
the waveform selection circuit includes a plurality of analog switches and a control circuit, and
the control circuit is configured to control ON and OFF switching of the plurality of switches based on an image signal.

16. The liquid ejection head according to claim 9, wherein
the second cancel pulse is input continuously following the first cancel pulse.
